(19) United States
(12) Patent Application Publication
(10) Pub. No.: US 2013/0280386 A1
(43) Pub. Date: Oct. 24, 2013

(54) POPCORN MACHINES AND OTHER FOOD SERVICE MACHINES HAVING COMMUNICATION CAPABILITIES, INCLUDING REMOTE AND NETWORK COMMUNICATION CAPABILITIES

(71) Applicant: C. CRETORS & COMPANY, Chicago, IL (US)

(72) Inventor: Andrew Cretors, Gurnee, IL (US)

(73) Assignee: C. CRETORS & COMPANY, Chicago, IL (US)

(21) Appl. No.: 13/866,923

(22) Filed: Apr. 19, 2013

Related U.S. Application Data
(60) Provisional application No. 61/635,811, filed on Apr. 19, 2012.

(51) Int. Cl. A23L 1/18

(52) U.S. Cl. CPC A23L 1/1812
USPC 426/233; 99/323.5

(57) ABSTRACT

Popcorn machines having communication capabilities are disclosed herein. Popcorn machines configured in accordance with the disclosure can include communication devices or components that provide remote notification of the status of operations of the machine and/or the indication of particular parameters. Several popcorn machines can be controlled remotely by mobile devices, personal computers, and/or other suitable devices. In some embodiments, notification that a popcorn machine requires maintenance or repair can be sent to a remote location and a user can be provided options to order parts or schedule repairs.

### CROSS-REFERENCE TO RELATED APPLICATION

This patent application claims the benefit under 35 U.S.C. §119 of U.S. Provisional Patent Application Ser. No. 61/635,811; filed Apr. 19, 2012; titled POPCORN MACHINES HAVING COMMUNICATION CAPABILITIES, INCLUDING REMOTE AND NETWORK COMMUNICATION CAPABILITIES, the disclosure of which is incorporated herein by reference in its entirety.

### TECHNICAL FIELD

The following disclosure relates generally to popcorn machines and other food service machines having communication capabilities, and more particularly to popcorn machines and other food service machines having remote or network communication capabilities for providing information related to operational status, malfunctions or other errors, remote operation, and the like.

### BRIEF DESCRIPTION OF THE DRAWINGS

FIG. 1 is a partially schematic isometric view of a popcorn machine having a communication system configured in accordance with an embodiment of the present disclosure.

FIG. 2 is a schematic diagram of a control assembly configured in accordance with an embodiment of the present disclosure.

FIG. 3 is a schematic diagram of the popcorn machine of FIG. 1 operating within a network environment in accordance with an embodiment of the present disclosure.

FIG. 4A is a partially schematic isometric view of a warming machine having a communication system configured in accordance with an embodiment of the present disclosure.

FIG. 4B is a partially schematic isometric view of a topper dispensing machine having a communication system configured in accordance with an embodiment of the present disclosure.

### DETAILED DESCRIPTION

Popcorn machines for producing popped corn are used in a variety of locations, e.g., individual homes, concession stands, restaurants, theaters, retail locations and industrial food production facilities. These popcorn machines can include sensors and electronic controls to aid or automate portions of the popping process. The electronic controls can maintain a desired temperature, alert an operator to an operating parameter, indicate an error or malfunction, or provide other functions. Although the electronic controls can provide several advantages, the benefits of the automation and the indication do not extend beyond the location of the machine, and may not result in the desired response. For example, popcorn machines operated in theater concession stands are often staffed by young workers without the skills or knowledge to conduct maintenance or replace parts. Accordingly, a notification to an operator that a malfunction has occurred may result in a less than prompt response.

Additionally, the popping process in existing popcorn machines may include several steps that are amenable to automation but still benefit from operator interaction, thus requiring the operator to be present at the machine. For example, popping machines can include automated operation cycles that can produce popped corn with differing ingredients, e.g., sweetened popcorn, savory popcorn, salted popcorn, etc. The ingredients are selected by the operator prior to initiating an operation cycle or a series of operation cycles. If the operator wishes to change the ingredients for a subsequent cycle, she has to alter the ingredient selection at the machine, either manually or through a control panel. If the operator is unable to promptly return to the machine, this can delay the production of the popped corn.

Several of the embodiments described below include features or advantages that overcome the above limitations of existing popping machines. However, reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description, or may be learned by the practice of the invention as set forth hereinafter. In order that the advantages of the invention will be readily understood, a description of the invention will be rendered by reference to specific embodiments that are illustrated in the appended drawings. Understanding that these drawings depict only typical embodiments of the invention and are not therefore to be considered to be limiting of its scope, the invention will be described and explained with reference to the accompanying drawings.

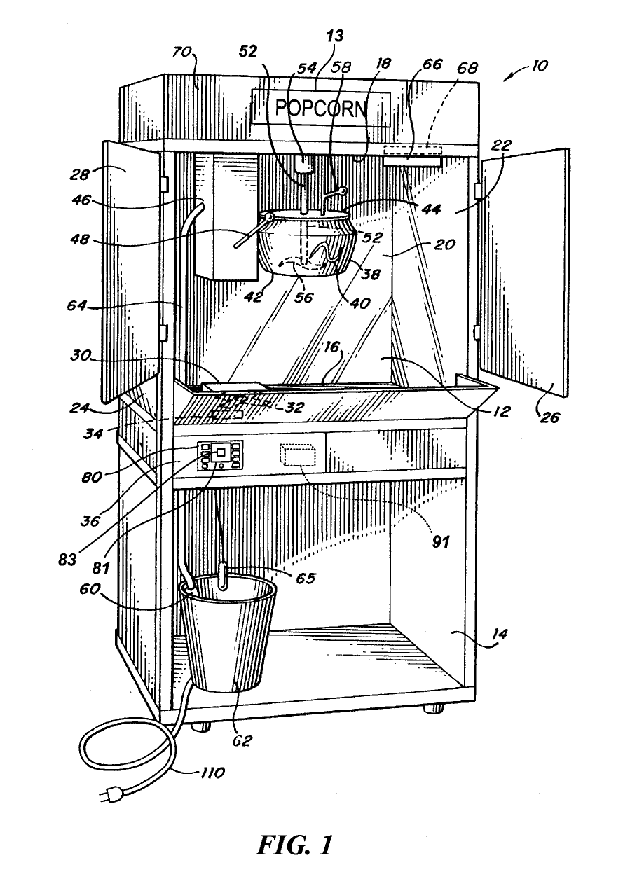

FIG. 1 is a partially schematic isometric view of a popcorn machine 10 having communication capabilities configured in accordance with the present disclosure. In the illustrated embodiment, the popcorn machine 10 includes a popcorn case or cabinet 12 for receiving popped corn, and a storage section 14. The storage section 14 can be used to store supplies, e.g., extra popping kernels, oil, containers and the like. The popcorn case 12 includes a bottom shelf 16, a top wall 18, a panel 20, and a pair of side walls 22 and 24. The panel 20 and the side walls 22 and 24 can be made of tempered glass, Plexiglas or other clear material to allow a view of the popping process and the popped corn which is stored in the popcorn case 12. A pair of hinged doors 26 and 28 provide access to the popcorn case 12. The hinged doors 26, 28 can also be made of Plexiglas and can pivot open to permit the operator to carry out cooking operations and to dispense popcorn when desired. The popcorn machine 10 can include a display sign 13 (shown schematically) having a monitor or display screen and speakers. The display sign 13 can display digital images and/or video, with or without accompanying audio. For example, the display sign 13 can display pricing information and/or advertisements. Additionally, although the schematically illustrated display sign 13 of FIG. 1 is positioned at an upper portion of the popcorn machine 10, in other embodiments the display sign 13 can be located at other suitable positions on the popcorn machine 10, and can be of a variety of suitable dimensions.

The popcorn case 12 has a hot air recirculating conditioner 30 mounted under the bottom shelf 16 and between the popcorn case 12 and the storage section 14. The conditioner 30 includes a blower 32, a heating element 34 and a thermostat which operate in conjunction to force hot air through the popped corn in the popcorn case 12 to keep it warm until it is ready to be served. In the illustrated embodiment, a control unit 36 is mounted under the bottom shelf 16 and between the popcorn case 12 and the storage section 14. The control unit 36 controls the blower 32, the heating element 34, and several of the remote communication features described below.

A kettle 38 for receiving popcorn kernels is suspended from the top wall 18 of the case 12. The kettle 38 can be supported on a pivot (not shown) carried on a support column 46 extending from the top wall 18 of the popcorn case 12. A kettle dump handle 48 is connected to the pivot. Operation of the dump handle 48 rotates the kettle 38 on the pivot to discharge popped corn into the popcorn case 12. A circular kettle cover 44 having a cover lift rod 58 is operably mounted on the kettle 38. The cover lift rod 58 can be operated to open the cover 44 and add popcorn kernels to the kettle 38. A drive shaft 52 extends through the center of the cover 44 and into an interior portion of the kettle 38. A proximal end of the drive shaft 52 is connected to a motor 54 and a distal end of the drive shaft 52 is connected to an agitator 56. The agitator 56 includes a plurality of mixing blades and is rotated by the motor 54 to agitate the kernels in the kettle 38.

The kettle 38 can be constructed of metal, a metal alloy (e.g., stainless steel) and/or other materials and can include heating elements 40. The heating elements 40 can heat oil contained within the kettle 38 to pop kernels of corn placed into the kettle 38 by the operator. A thermocouple 42 is fixedly attached to the kettle 38 and operably coupled to the control unit 36. The thermocouple 42 can measure the temperature of the kettle 38.

In several embodiments, the kettle 38 and/or the conditioner 30 can include one or more temperature sensors, such as two temperature sensors (e.g., thermostats or thermocouples) to measure temperature. The first temperature sensor can be an operational temperature sensor that measures and/or controls the temperature within an expected temperature range, and the second temperature sensor can be a high-limit temperature sensor that can provide a back-up temperature measurement. In several embodiments, the second temperature sensor can initiate the removal of power from the kettle 38 (and/or other components) upon the temperature reaching a pre-determined level.

An oil pump 60 is operably positioned in an oil container 62 located within the storage section 14. In the illustrated embodiment, the oil container 62 is a pail. In other embodiments, the oil container 62 can be a bag of oil in a corrugated cardboard container (e.g., a “bag-in-box”). The oil pump 60 can pump oil from the oil container 62 through a tube 64 to the kettle 38. The oil in the container 62 can be solid at room temperature. A heating element 65 can be inserted into the solid oil to liquefy the oil. The heating element 65 can be operated for a set time period to ensure liquefaction prior to initiation of popping operations. In embodiments having bag-in-box oil containers, a heat pad can be positioned adjacent or proximate to the container to heat the oil.

A light 70 and an exhaust blower 66 are mounted in the top wall 18 to illuminate and ventilate, respectively, the popcorn case 12. A filter assembly 68 is included in the exhaust path to reduce undesirable odors and airborne oils from the area around the popcorn machine 10. The filter assembly 68 can include one or more filters, e.g., a grease filter, an electrostatic filter, a charcoal filter, and/or a high-efficiency particulate air (HEPA) filter. Although the filter assembly 68 and the exhaust blower 66 are shown schematically in a particular arrangement, it is to be understood that these components can be arranged in a variety of manners and can include a variety of additional components. For example, the respective positions of the filter assembly 68 and the blower 66 in the illustrated embodiment can be reversed. Additionally, a variety of filtration systems can be incorporated into the popcorn machine 10, including filtrations systems produced by Giles Enterprises, Inc., of Montgomery, Ala.

The control unit 36 is electrically connected to the oil pump 60, the motor 54, the heating elements 40, 34 and 65, the thermocouple 42, the blower 32, and the exhaust blower 66. The control unit 36 includes a control panel 80 and a control assembly 91 (shown schematically). The control panel 80 can have a variety of buttons, switches, controls, and/or displays, including a touchscreen 81. The touchscreen 81 can include one or more buttons 83, and a user can operate various components of the popcorn machine 10 via the control panel 80, as further described below. The control assembly 91 can include a communication system or communication device for wired or wireless communications, as also further described below. A power cord 110 is connected to the control unit 36 to provide the popcorn machine 10 with the necessary electrical power to operate the various components. In one embodiment, the power cord 110 can be a conventional three line power cord which may be plugged into a conventional 120 volt power source. In other embodiments, the popcorn machine 10 and the power cord 110 can be configured for power sources having other voltages. For example, the power cord 110 can be configured to be plugged into 240 volt power sources and/or three-phase power sources.

The popcorn machine 10 is a representative example of various different popcorn machines and other food service machines (e.g., warming machines, topper dispensing machines, hot dog grilling machines, etc.) that can include the communication systems described herein. In other embodiments, the communication systems disclosed herein can be used with other types of food service machines. Accordingly, the present disclosure is not limited to the particular embodiments of popcorn machines and other food service machines disclosed herein.

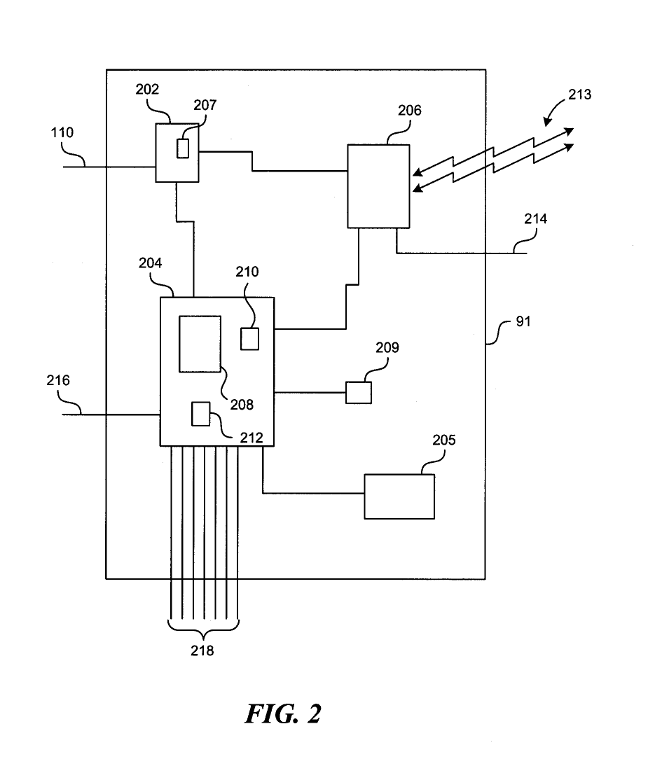

FIG. 2 is a schematic diagram of the control assembly 91 configured in accordance with an embodiment of the present disclosure. In the illustrated embodiment, the control assembly 91 includes a power supply 202, a printed circuit board or controller 204, a data storage device 205, a positioning device 209 and a communication system or communication device 206 (e.g., an ethernet card, a wireless transceiver, an antenna, a modem, a near field communication (NFC) device, or another device capable of wired and/or wireless communication). The power supply 202 is electrically connected to the power cord 110 and to the controller 204 and can include a battery 207. The controller 204 can include a processor 208, memory 210, a display driver 212, and various other suitable electronic components. The communication device 206 is electrically connected to the power supply 202 and the controller 204, and can include a wireless external connection 213 or a wired external connection 214. The wired external connection 214 can include a modular connector for an ethernet connection, a USB connector, a modular connector for a telephone line connection, or any other connector suitable for wired connections for communications. A control line 216 can electrically connect the controller 204 to the control panel 80 (FIG. 1). Power lines or signal lines 218 can extend from the controller 204 to operably connect the control assembly 91 to various components of the popcorn machine 10 (or controllers or components associated therewith), e.g., the kettle 38, the oil pump 60, the blower 32, the sign 13, etc. The battery 207 can provide back-up power in the event of a loss of electrical power from the power cord 110 or a power loss due to a fire or other hazardous condition associated with the popcorn machine 10, as will be further described below.

In several embodiments, it can be desirable for a remote user to determine the location of the popcorn machine 10. For example, a technician may need to be notified of the location of a particular popcorn machine 10 to respond to, e.g., a call for maintenance. The controller 204 can operate with the positioning device 209 and/or the communication device 206 to determine a location of the popcorn machine 10. For example, the positioning device 209 can be an antenna or other receiver or transceiver (e.g., a Global Positioning System (GPS) antenna or module, a cellular antenna, Wi-Fi antenna, etc.). The controller 204 can execute software that determines the position of the popcorn machine 10 based on signals received by the communication device 206 or the positioning device 209 (e.g., GPS signals, GPRS signals, Wi-Fi signals, etc.).

The data storage device 205 can include a hard disk drive, a solid state drive, a memory card device and/or any other device or component capable of storing computer readable data, files and/or instructions. For example, in some embodiments, the data storage device 205 can include a memory card device capable of writing data to a Secure Digital (SD) card. The data storage device 205 can be electrically connected to the controller 204 and/or the power supply 202 and can contain operating instructions, data, digital advertising (e.g., digital images and/or videos), and/or other digital information. In some embodiments, the data storage device can receive operational information related to the use of the popcorn machine 10. For example, the controller 204 can execute computer readable instructions that can track the number of batches of popcorn that have been popped and send the information to the data storage device 205. In some embodiments, a user can retrieve the information from the data storage device 205 via an SD card and/or via the communication device 206.

In some embodiments, an audio device (e.g., a speaker) can be operably coupled to the control panel. The audio device can be configured to produce audible tones, alerts, or spoken words that indicate different operating conditions, including the completion of a popping cycle, a low level of cooking oil or other ingredients and/or other conditions. For example, a recorded voice can be played through speakers to indicate that a popping cycle is nearing completion. Although the illustrated embodiment of FIG. 2 includes a controller 204, a power supply 202 and a communication device 206, the technology disclosed herein can be configured in a variety of suitable configurations. For example, it is within the scope and spirit of the present disclosure to include circuit boards, expansion cards, processors, modems, and/or other electronic devices in the popcorn machine 10, and/or other popcorn machines or food service machines, to provide communication capabilities.

Various operations and cycles of the popcorn machine 10 (FIG. 1) can be initiated or controlled through the control panel 80. For example, the control panel 80 can include a variety of buttons, indicators, displays, touchscreens, lights and/or other suitable components that a user can interact with to operate the popcorn machine 10. In one embodiment, a user interacts with the touchscreen 81 to control various functions of the popcorn machine 10. For example, in operation, a variety of different control options can be presented to the user on the touchscreen 81. An Oil Heat Button can be graphically represented on the touchscreen 81 and a user can touch the location of the Oil Heat Button on the touchscreen 81 to turn on the heating element 65 (FIG. 1). After a predetermined time sufficient for liquefaction of the oil, the touchscreen 81 can indicate that the machine is ready to initiate a popping cycle and that corn kernels should be added to the kettle 38. A Start Button can be presented on the touchscreen 81 and the user can be prompted to press the Start Button when the user is ready to begin popping. Pressing the Start Button can initiate a variety of functions on the popcorn machine 10. For example, the controller can direct the oil pump 60 to pump a predetermined amount of oil to the kettle 38 and energize the heating elements 40 to begin heating the corn kernels. The agitator 56 can be activated to agitate the corn kernels and the exhaust blower 66 can be activated to remove odors, oil and/or particulates. The touchscreen 81 can also include a Clean Button that can initiate a cleaning cycle to heat the kettle to a predetermined temperature for a set period of time.

Although the illustrated embodiment of FIG. 1 illustrates the touchscreen 81 as having a particular size, popcorn machines and other food service machines in accordance with the present technology can include touchscreens and/or control panels of a variety of suitable sizes, shapes, colors, etc. For example, in some embodiments the touchscreen 81 can have a diagonal screen size of 7 inches (18 cm) or more. Additionally, the touchscreen 81 and/or other components can be configured for multiple languages. For example, the touchscreen 81 can include a graphical user interface (GUI) that is configured to display control options in two or more languages. In a particular embodiment, a user can be presented with an option for a selection from one of multiple languages. Upon selection of a desired language, the control panel 80 can present the control options in the selected language. Additionally, although the control panel 80 includes the touchscreen 81, other control panels may include a screen that does not have touch capabilities, and the user can interact with the popcorn machine 10 via one or more buttons, trackballs, keyboards, etc.

In several embodiments, the touchscreen 81 and/or the display sign 13 can present information to a user to assist in operation of the popcorn machine 10. For example, users manuals, operating instructions, and/or other information can be presented to a user. In some embodiments, videos providing demonstrations and/or instructions for operation, cleaning and/or maintenance of the popcorn machine 10 can be presented on the touchscreen 81 and/or on the display sign 13. The videos and/or other digital information can be received via the communication device 206 and can be stored in the data storage device 205. In several embodiments, the touchscreen 81 can include a Help Button (e.g., the button 83 shown in FIG. 1) that a user can press to request help from a technician, manufacturer, servicing company, or other third party. In some embodiments, the Help Button 83 can be restricted to use by authorized personnel or technicians. For example, the Help Button 83 may provide access to a servicing company and may only be available to managers of a facility or other particular users.

The controller 204 can be configured to automatically complete various operations of the popcorn machine 10. For example, the controller 204 can turn off power to the heating elements 40 after a predetermined amount of time or after a predetermined temperature has been reached (e.g., as measured by the thermocouple 42). The controller 204 can turn off power to the agitator 56 and/or the exhaust blower 66 after a predetermined time, and can provide an indication on the touchscreen 81 that the popping cycle is complete.

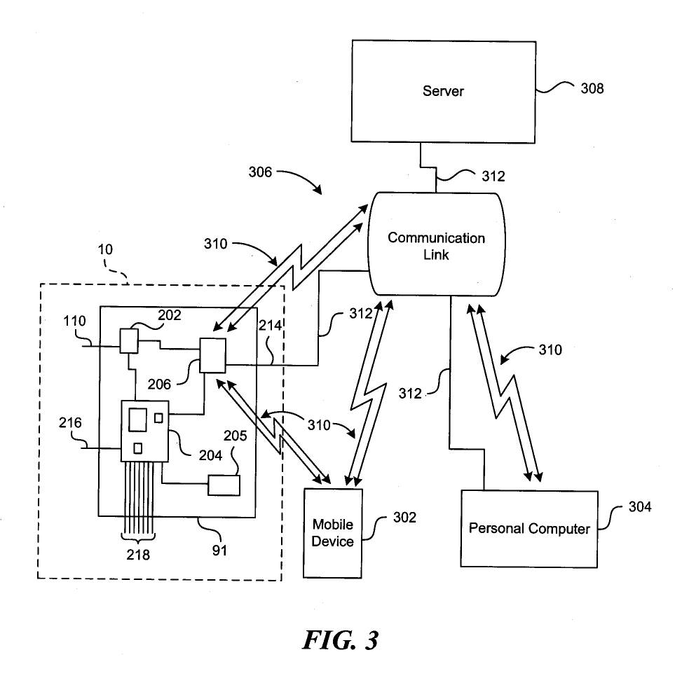

FIG. 3 is a schematic diagram of the popcorn machine 10 operating within a network environment in accordance with an embodiment of the present disclosure. In the illustrated embodiment, the control assembly 91 of the popcorn machine 10 is operably connected to several computing devices through a communication link 306. The communication link 306 can include various switches, routers, hubs, modems and/or other components or devices known in the art. For example, the communication link 306 can be connected to, or be part of, the Internet. The communication link 306 can include the wireless external connection 213 (FIG. 2), wireless connections 310 and/or wired connections 312. A computer or personal computer 304, a mobile device 302, and/or a server 308 can communicate with the control assembly 91 through the wired connections 312 and/or through the wireless connections 310 of the communication link 306. In some embodiments, communications between the control assembly 91 and the mobile device 302 and/or the personal computer 304 are direct, without passing through any other communication devices. For example, the mobile device 302 can directly communicate with the communication device 206 of the control assembly 91 via the wireless connection 310, as shown in FIG. 3. In several embodiments, the mobile device 302, the personal computer 304 and/or the server 308 can communicate with the popcorn machine 10 through a series of connections that are part of the communication link 306 (e.g., through routers, hubs, fiber optic lines or other components that are part of the Internet).

In one aspect of the present disclosure, the personal computer 304 or the mobile device 302 can remotely control or operate the popcorn machine 10 through the communication link 306. For example, the mobile device 302 can be a smart phone or other mobile computing system that can run software programs, applications, or “apps” that can provide for interaction with the popcorn machine 10. In one embodiment, an app on the mobile device 302 can provide indications and control similar to the touchscreen 81 described above with respect to FIG. 1. For example, when the popcorn machine 10 is ready to initiate a popping cycle, the control assembly 91 can send a signal to the mobile device 302 through the communication link 306. In response to the signal, the mobile device 302 can provide an indication to the user that the popcorn machine 10 is ready for popping (e.g., by presenting a Start Button on a screen on the mobile device 302). The user can press the Start Button and an electronic command can be transmitted from the mobile device 302 to the popcorn machine 10 through the communication link 306 to start a popping cycle. The popcorn machine 10 can start the popping cycle and communicate through the communication link 306 with the mobile device 302 to indicate that the popping cycle has started. At the end of a popping cycle, the popcorn machine 10 can send an electronic signal to the mobile device 302 through the communication link 306 and the mobile device 302 can provide an indication to the user that the popping cycle is complete. These and several other suitable functions and controls can be implemented with the popcorn machine 10 and/or with other popcorn machines configured in accordance with the present disclosure.

In addition to the mobile device 302, the personal computer 304 can interact with the popcorn machine 10. i.e., in a manner generally similar to that described above with respect to the mobile device 302, the personal computer 304 can communicate with the popcorn machine 10 through the communication link 306. Electronic commands to initiate operations or provide status can be sent between the personal computer 304 and the popcorn machine 10 and a software program on the personal computer 304 can display indications and control options.

In another aspect of the present disclosure, the popcorn machine 10 can communicate with the mobile device 302, the personal computer 304, and/or with a telephone or mobile phone to provide an indication of a fault or a notification of the need for maintenance. For example, a sensor (e.g., the thermocouple 42) can be provided in the popcorn machine 10 to monitor various operations or conditions. The controller 204 can interact with the sensor to gather information that can be communicated to remote devices (e.g., the mobile device 302 and/or the personal computer 304). In one embodiment, a sensor can be positioned to monitor the efficiency or performance of the filter assembly 68 (FIG. 1) in the popcorn machine 10. The controller 204 can be configured to send a signal to a remote device when the sensor indicates that the filter assembly 68 has become clogged and needs cleaning or replacement, and/or if the filter assembly 68 is malfunctioning. The filters of the filter assembly 68 of FIG. 1 can be monitored with sensors configured in a variety of manners. In one embodiment, the sensor can include a pressure transducer that monitors the pressure within a filter passage. In other embodiments, an electrostatic filter can be monitored by measuring an electrical parameter (e.g., current, voltage, resistance, etc.). In several embodiments, the popcorn machine 10 can provide a notification via a voicemail or text message sent to a telephone or mobile phone. For example, in some embodiments, the popcorn machine 10 can send a text message or other notification to indicate that it is running low on a consumable product (e.g., oil, flavorings, etc.) and needs replenished.

In some embodiments, timers, counters or other devices can monitor or track usage of the popcorn machine 10 to indicate when maintenance is needed and/or provide other information. For example, a timer can record the operation of the exhaust blower 66. When the exhaust blower 66 has operated for a predetermined period of time, the controller 204 can provide a signal to a remote device to indicate that a filter change is necessary. In several embodiments, a thermostat or thermocouple (e.g., the thermocouple 42) can be monitored to provide an indication of the number of popping cycles. After a given number of popping cycles the controller 204 can send a signal indicating that maintenance should be performed. The number of popping cycles can also be monitored via other means. For example, the controller 204 can monitor the number of times a particular button (e.g., the Start Button on the touchscreen 81) is pressed or activated. In several embodiments, a switch or sensor can provide an indication each time the kettle 38 is rotated to discharge popcorn into the popcorn case 12, and the controller 204 can track the numbers and provide an indication of the number of batches. In some embodiments, data associated with operation of the pump 60 can be used to determine the number of popping cycles. For example, a timer can track how long the oil pump 60 has run and the controller 204 can calculate a number of batches based on the total length of time. Furthermore, the number of cleaning cycles can be monitored and reported.

In several embodiments, the number of popping cycles or other operational data can be used to track sales numbers, revenue, profitability, and/or other business information. For example, the popcorn machine 10 can track the number of popping cycles and create a data file in the data storage device 205 (FIG. 2) that includes the popping cycle information. The data file can be locally accessed and/or remotely accessed by a user (e.g., retrieving the data via an SD card or via the communication link 306 (FIG. 3)). In some embodiments, the popcorn machine 10 can automatically send the data file and/or other information to the server 308 and/or other computing systems or devices.

Sensors or other components can provide a variety of additional suitable information, such as the remaining amount of ingredients or other consumables in the popcorn machine 10. For example, a sensor can be positioned to monitor the remaining amount of oil in the container 62 and provide an indication of the amount of oil to the user through the communication link 306. In some embodiments, the controller 204 and/or other components can monitor electrical parameters or other conditions to provide an indication of faulty connections, broken components or other malfunctions. The electrical resistance of the heater elements 40, for example, can be monitored and an indication can be provided through the communication link 306 if the resistance is outside of a predetermined range. The thermocouple 42 can be monitored by the controller 204 to detect high temperature conditions. If the temperature is above a predetermined level a particular number of times or for a particular amount of time, the controller 204 can remove power to the kettle 38 and send an indication to the user and/or to a third party (e.g., a technician or service center to provide a notification that a repair is necessary).

The communication link 306 can be used by remote third parties (e.g., machine operators) to provide for updates to the display sign 13 (FIG. 1). For example, pricing updates, advertisements, promotions, videos (or other digital entertainment), and/or other digital content can be sent to the controller 204 via the communication link 306. The controller 204 can present the content on the display sign 13 and/or store the digital content on the data storage device 205.

The electrical current drawn by several components of the popcorn machine 10 can be monitored to provide an indication of faults. In one example, the electrical current drawn by the motor 54 can be monitored to determine whether it is within a predetermined range. If the electrical current is outside of the predetermined range, it could be indicative of binding components, faulty wiring, or another electrical or mechanical fault. In response to a measurement of current outside of the predetermined range, the controller 204 can provide an indication of the fault to a user through the communication link 306. Additionally, fuses, circuit breakers or other electrical components can be provided to remove power to one or more components (e.g., the heater elements 40, the motor 54, etc.) if too much current is drawn. The controller 204 can monitor the continuity of circuits having the fuses or circuit breakers. When a fuse blows or a circuit breaker trips, the controller 204 can detect the lack of continuity and send notification to the user through the communication link 306 indicating that service is required.

In some embodiments, a fire suppression system can be included in the popcorn machine 10 to aid in suppressing fires. For example, an Ansul Fire Suppresion System (available from Tyco International of Marinette, Wis.) can be incorporated within the popcorn machine 10. In some embodiments, the fire suppression system can include one or more fusible links that can trigger the system and/or remove power to one or more components. In several embodiments, even in the event of a fire, power can continue to be delivered via the power cord 110 and/or via the battery 207 to the communication device 206 and/or other components associated with the control assembly 91. In such embodiments, even if power is not being delivered to the kettle or other components, the communication device 206 can retain power and send a notification to a remote user and/or to emergency personnel (e.g., via the 911 telephone system).

In addition to the personal computer 304 and the mobile device 302, the server 308 can communicate with the popcorn machine 10 to provide various functions related to operation and/or maintenance of the popcorn machine 10. In a manner generally similar to that described above with respect to the mobile device 302 and the personal computer 304, the server 308 can interact with the popcorn machine 10 through the communication link 306. The server 308 can be configured to receive information from the popcorn machine 10 and send a notification to a particular user. The notification can be one or more email messages, text messages, telephone messages, or other suitable notification. In some embodiments, the server 308 can operate as an intermediary between a third party and a user utilizing the mobile device 302 and/or the personal computer 304. In one example, the server 308 can send a signal to the mobile device 302 to notify the user of a fault or a particular condition and a series of potential options. For example, the server 308 can send a notification that the popcorn machine 10 requires a filter replacement, and provide an option to order a filter and/or schedule a filter replacement by a technician. If the user schedules a filter replacement, the server 308 can send a notification of the scheduled appointment to a third party. If the user orders a filter, the server 308 can send a notification of the order to the third party, or a different party. In one embodiment, the server 308 can run software that monitors multiple popcorn machines and provides interaction with multiple parties for repairs and/or replacement parts. The server 308 can be controlled, owned, and/or operated by any of a variety of suitable persons or parties, including the manufacturer of the popcorn machine 10, a distributor of popcorn machines, a maintenance company, a telecommunications company, and/or a group of users.

In several embodiments, the communication device 206 provides for a remote login to the popcorn machine 10 for troubleshooting of software and/or hardware. For example, the controller 204 can create log files of operations, and a technician can use a computing device to login to the popcorn machine 10 and read the log files to determine the cause of a fault. After a correction of a fault or completion of a repair or service, a technician can reset the fault notification locally and/or via the remote login. Additionally, a variety of data, software, and/or other digital information can be downloaded to the popcorn machine 10 via a local or remote operator. For example, updated operating parameters (e.g., cooking times, fan speeds, etc.), diagnostic software, bug fixes, updated pricing, and/or other digital content can be downloaded to the machine. The level of access to software, user interface controls and options, and/or other features of the popcorn machine 10 can be limited based on a user's permission level. For example, in some embodiments, any user may be able to modify one or more options for a GUI (e.g., selecting a preferred language), but only technicians may be able to alter an amount of time that the heating elements 40 will be energized. Such permission levels can be varied for local and/or remote operations.

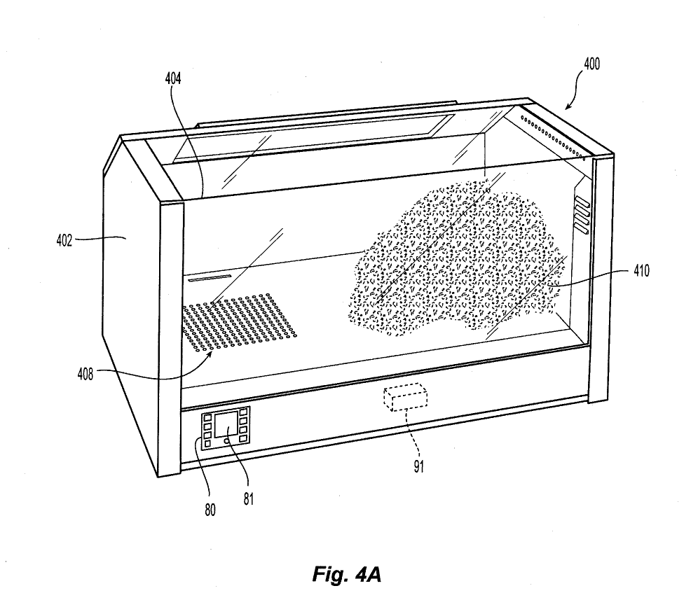

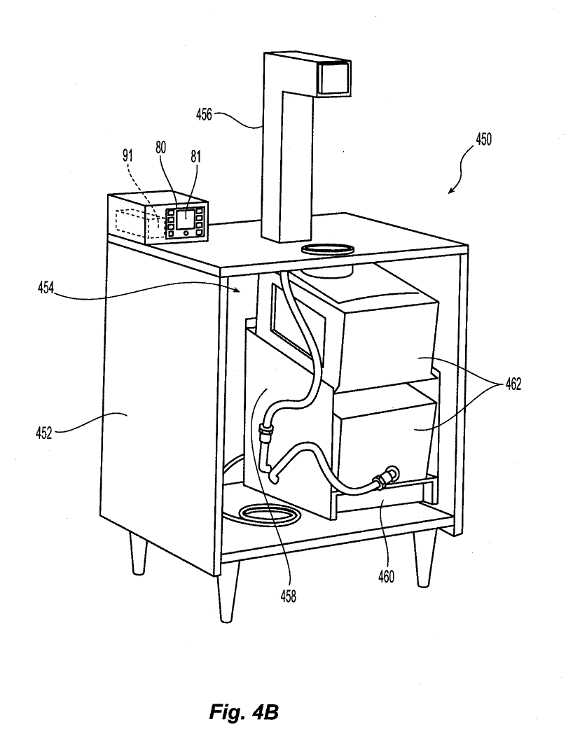

Embodiments in accordance with the present technology can include a variety of food service machines having communication capabilities. FIG. 4A is a partially schematic isometric view of a warming machine 400 having a communication system configured in accordance with an embodiment of the present disclosure. In the illustrated embodiment, the warming machine 400 includes a case 402 having a warming chamber 406 for warming popcorn 410. A glass panel 404 provides visibility to the chamber 406, and a heating and ventilation system 408 (only partially visible) provides warm air to the chamber 406. The warming machine 400 can include several features that are at least generally similar to the popcorn machine 10. For example, the warming machine 400 includes a control assembly 91 and a control panel 80 having a touchscreen 81. Similar to the popcorn machine 10, various operations of the warming machine 400 can be controlled via the control panel 80 and the control assembly 91. For example, the control panel 80 can be used to activate the warming machine 400. Various operational data can be sent from the control assembly 91 to remote devices via a communication system or communication device 206 (FIG. 2), and the warming machine 400 can be operated via a remote device.

FIG. 4B is a partially schematic isometric view of a topper dispensing machine 450 having a communication system configured in accordance with an embodiment of the present disclosure. The topper dispensing machine 450 includes a case 452, a dispensing neck 456 and a flavoring assembly 454. The flavoring assembly can include a frame 458 for supporting one or more bag-in-box containers 462 of flavorings. The frame 458 can include a base 460 housing a flavoring pump (not shown) for dispensing flavoring and a heat pad (not shown) to heat the flavoring. The topper dispensing machine 450 can include several features that are at least generally similar to the popcorn machine 10 and the warming machine 400. For example, the topper dispensing machine 450 includes a control assembly 91 and a control panel 80 having a touchscreen 81.

Similar to the popcorn machine 10, various operations of the topper dispensing machine 450 can be controlled via the control panel 80 and the control assembly 91. For example, the control panel 80 can be used to activate the pump or the heat pad. Various operational data can be sent from the control assembly 91 to remote devices via a communication system or communication device 206 (FIG. 2), and the topper dispensing machine 450 can be operated via a remote device. In some embodiments, the level of flavoring remaining in the bag-in-box containers 462 can be transmitted to a remote device. In several embodiments, an indication of a fault or the need for a repair or a replacement part can be transmitted via the control assembly 91.

Food service machines in accordance with the present technology can include a variety of features. For example, although the popcorn machine 10 includes a kettle 38 suspended from a top wall 18 of the popcorn machine 10, in other embodiments, popcorn machines can have kettles positioned in other locations (e.g., supported from below). Additionally, although the kettle 38 includes electrical heating elements 40 other embodiments can include a kettle heated by flames (e.g., a kettle heated by a burning gas) or other heating methods or sources. Embodiments in accordance with the present technology can also include popcorn machines that do not include kettles, e.g., popcorn machines having popping chambers heated by air. In several embodiments, popcorn machines and/or other food service machines in accordance with the present technology can include features at least generally similar in structure and function to those described in U.S. Pat. No. 5,662,024, entitled SOLID STATE CONTROLLED POPCORN MACHINE, and filed May 10, 1996, U.S. Pat. No. 6,234,063, entitled SOLID STATE CONTROLLED POPCORN MACHINE, and filed Oct. 5, 2000, U.S. patent application Ser. No. 12/890,370, filed Sep. 24, 2010, and entitled SYSTEMS AND METHODS FOR POPPING CORN AND PRODUCING OTHER TYPES OF EXPANDED FOODS, and/or U.S. Patent Application No. 61/635,805, filed Apr. 19, 2012, and entitled Air Popcorn Popper, each of which is incorporated herein by reference in their entireties.

From the foregoing, it will be appreciated that specific embodiments of the invention have been described herein for purposes of illustration, but that various modifications and variations can be made without departing from the spirit or scope of the various embodiments of the invention. Further, while various advantages have been described above in the context of those embodiments, other embodiments may also exhibit such advantages, and not all embodiments need necessarily exhibit such advantages to fall within the scope of the invention.

I/We claim:

1. A popcorn machine comprising:
a kettle for popping corn, the kettle including a heating element;
a controller operably coupled to the heating element to control the energization of the heating element; and
a communication device operably coupled to the controller and configured to transmit operational information to a remote device.

2. The popcorn machine of claim 1, further comprising:
a data storage device operably coupled to the controller, wherein the kettle is configured to sequentially pop multiple batches of corn, and wherein the controller counts the batches of corn that have been popped and stores the count on the data storage device.

3. The popcorn machine of claim 1, further comprising:
a data storage device operably coupled to the controller, wherein the kettle is configured to sequentially pop multiple batches of corn, and wherein the controller counts the batches of corn that have been popped and stores the count on the data storage device; and
a display sign operably coupled to the controller, wherein the controller receives information from a remote computer via the communication device and alters the display sign based on the information.

4. The popcorn machine of claim 1 wherein the kettle is configured to sequentially pop multiple batches of corn, and wherein the popcorn machine further comprises means for counting the batches of corn that have been popped.

5. The popcorn machine of claim 1, further comprising a sensor positioned to measure an amount of cooking oil stored within the popcorn machine, and wherein the operational information includes the amount of cooking oil.

6. The popcorn machine of claim 1, further comprising:
a popcorn case, wherein the kettle is positioned within the popcorn case;
a filter assembly positioned to filter air from the popcorn case; and
a sensor positioned to measure performance of the filter assembly, wherein the operational information includes information related to the performance of the filter assembly.

7. The popcorn machine of claim 1, further comprising an oil pump operably coupled to the controller and positioned to pump oil to the kettle, wherein the operational information includes data associated with operation of the oil pump.

8. The popcorn machine of claim 1 wherein the operational information includes an indication of a fault.

9. A popcorn machine comprising:
a popcorn case for receiving popped corn;
a controller for controlling and monitoring operations of the popcorn machine; and
a communication device for transmitting information related to operation of the popcorn machine to a remote device.

10. The popcorn machine of claim 9 wherein the information includes an indication of a fault.

11. The popcorn machine of claim 9, further comprising a filter assembly positioned to filter air from the popcorn case, and wherein the information includes data associated with the efficiency of the filter assembly.

12. The popcorn machine of claim 9 wherein the information includes a notification that a component of the popcorn machine should be replaced.

13. The popcorn machine of claim 9 wherein the information includes a notification that a consumable product needs replenished.

14. The popcorn machine of claim 9, further comprising a sensor positioned to determine an amount of popping oil stored within the popcorn machine, and wherein the operational information includes the amount of popping oil.

15. The popcorn machine of claim 9, further comprising:
a kettle positioned within the popcorn case; and
a sensor positioned to detect when the kettle is rotated to discharge popcorn, wherein the operational information includes a number of batches of corn that have been popped in the kettle, and wherein the number of batches is based on signals from the sensor.

16. The popcorn machine of claim 9 wherein the operational information includes a number of batches of corn that have been popped in the kettle, and wherein the number of batches is based on the number of times a control button on the popcorn machine has been pressed.

17. A method for monitoring the popping of corn, the method comprising:
popping a plurality of batches of corn in a kettle;
counting the batches via a controller to determine a number of batches popped; and
transmitting data to a remote device via a communication device, wherein the data is related to the number of batches.

18. The method of claim 17 wherein popping a plurality of batches of corn in a kettle includes pumping oil to the kettle with an oil pump, and wherein counting the batches includes monitoring an amount of time that the oil pump runs.

19. The method of claim 17 wherein monitoring the number of batches includes monitoring the number of times the kettle is rotated to discharge popcorn.

20. The method of claim 17 wherein the kettle is positioned within a popcorn case, the method further comprising:
filtering air from the popcorn case with a filter assembly;
monitoring the efficiency of the filter assembly; and
transmitting data associated with the efficiency of the filter assembly to the remote device via the communication device.

21. The method of claim 17, further comprising:
transmitting advertising information to the communication device; and
presenting the advertising information on a display sign.
